(19) United States
(12) Patent Application Publication
(10) Pub. No.: US 2013/0151425 A1
(43) Pub. Date: Jun. 13, 2013

(54) Method and system for buying and renting real properties

(71) Applicant: Albert Feinstein, New York, NY (US)

(72) Inventor: Albert Feinstein, New York, NY (US)

(21) Appl. No.: 13/709,490

(22) Filed: Dec. 10, 2012

Related U.S. Application Data
(60) Provisional application No. 61/568,243, filed on Dec. 8, 2011.

(51) Int. Cl. G06Q 50/16; G06F 17/27

(52) U.S. Cl. CPC G06Q 50/16; G06F 17/27
USPC 705/313; 704/9

(57) ABSTRACT

In accordance with a computer-implemented approach and computer system, user conducts a search for real estate properties using natural language and has the ability to buy or rent real property online using unique functionalities not available in prior art. A “Natural Search” approach allows user to conduct an online search of real estate properties using natural language as opposed to standardized pre-determined search terms. Based on user's natural search, the system administrator generates a series of results using the “Interactive Results” approach, which enables the apparatus to analyze users' preferences to create a list of matching real estate properties and provide interactive features allowing user to act on generated results. According to “Live Offer” approach, the computer system generates an offer history and unique data for each property and allows user to act on the data by submitting an offer and, otherwise, completing the buying and renting process online. All three approaches may be used together or separately to streamline, simplify and improve the process of buying and renting real property.

### RELATED APPLICATION DATA

This application claims priority from U.S. Provisional Patent Application No. 61/568,243 for METHOD AND SYSTEM FOR BUYING AND RENTING REAL PROPERTIES filed on Dec. 8, 2011, the entirety of which is incorporated herein by reference for all purposes.

### FIELD OF THE INVENTION

The present invention is related to computers and computer software, and to the provision of services to users desiring to buy or rent real estate.

### BACKGROUND OF THE INVENTION

Traditional methods for buying and/or renting of real properties are complex and time consuming. Potential buyers and renters who do not use expensive brokerage services are at a disadvantage starting from the initial search for the property and throughout the whole process. The search process is time consuming and normally involves a large pool of properties that are of no interest to the buyer. Even if the buyer can sort through the vast number of properties and find several properties that best match buyer's preferences, buyer does not have access to pertinent information about the market value of the property, specific building rules affecting ownership of the property, financing options or the prior offers history and seller's responses. In addition, prospective buyer normally needs not only the services of a real estate broker, but also professional legal services to help put an offer for the property, negotiate purchase/rental agreement and close the transaction.

Currently, different forms of searching for real properties online exist. Such search forms are performed based on pre-selected criteria, also known as Boolean search. In a typical Boolean search, a search system examines the database for pre-selected criteria or absence thereof. Another example of typical computer search used by real estate professionals and potential buyers and renters is the multiple listing system (MLS). A search method utilized in MLS searches a database of real estate listings for exact matches to standardized pre-selected criteria, like price, number of bedrooms, square footage.

Such search methods are inadequate because it is virtually impossible to include all features that a buyer or renter might desire to see in real property. The search systems based on standardized pre-selected criteria are very limited and leave out properties that might be of interest to the prospective buyer because one or several of the criteria could not be pre-selected. For example, usual search criteria include the number of bedrooms, the type of building or the price but do not include criteria like the average tenants' age, the type of street where the property is situated (tree-lined, industrial, etc.) or proximity to other point of interest (schools, hospitals, etc.). On the other hand, the search systems based on pre-selected criteria tend to be highly over-inclusive. The listings satisfying pre-selected criteria, like the number of bedrooms, can still be dissatisfying to the prospective buyer or renter. This type of search is ineffective and time consuming, because it requires the user to examine a large number of listings that are otherwise irrelevant. This makes searching for real properties frustrating and time consuming.

Attempts have been made to expand the usual search options available to users, like in U.S. Pat. No. 5,754,850. Unlike traditional search methods, this method considers “near” matches in addition to exact matches. This patent performs search that starts with a selection of number of pre-selected search features. While this search improves the limitations of the regular Boolean search, it makes the resulting pool of property even more over-inclusive. In addition, it still does not address specific and unique needs of the prospective buyer or renter.

The present invention alleviates this problem by enabling user to conduct non-standardized natural language search. The real properties generated by the system administrator and delivered to the user match unique preferences of each user.

In addition to time consuming and complex search process, potential buyers and renters are at a disadvantage because the information available to potential buyers and renters regarding each selected property is extremely limited. Often buyers and renters are unfamiliar with the area, sales data and specific information potentially affecting their future interest in the property; such information property is not available via traditional real estate computer networks.

Attempts have been made to facilitate the whole transaction of buying and selling real properties online and provide buyers with more information beyond what traditional real estate computer networks provide, like in U.S. Pat. No. 6,594,633 and U.S. Pat. No. 6,684,196. Unlike traditional methods, these patents have attempted to streamline the process of buying real estate online by providing user with market data and tool to complete the transaction online. While these methods considerably simplify the process of buying real estate, they do not provide the users with enough information and adequate tools to make an educated decision to place an offer on a particular real estate property. The present invention addresses these and other concerns that arise during buying or renting of real properties by providing method and computer system that enable the user to search for properties that match user's unique preferences and provide to the user unique information and functionalities not available in prior art.

### BRIEF SUMMARY OF THE INVENTION

a. According to one aspect of the invention, a user interested in purchasing or renting real property has the unique ability to conduct a search using natural language. Under the “Natural Search” approach, the system administrator analyzes the natural language search criteria submitted by the user and generates a limited number of search results based on user's narrow and personalized preferences.
b. According to another aspect of the invention, a method is provided whereby the system generates limited number of results based on the user's natural language search criteria, and provides the user with the opportunity to act on these results. The “Interactive Results” approach allows the user to accept or reject the search results. If user is dissatisfied with the search results, user can reject the results by providing to the system reasons for such rejection and commentary. The system administrator analyzes the reasons and commentary provided by the user, integrates such reasons into user's previous search and generates a new narrow list of real estate properties. User's commentary is stored by the system and available to subsequent users.
c. According to another aspect of the invention, a method is provided that gives user the unique tools necessary to review property data and initiate sale. As part of “Live Offer” approach the system generates offer history for each property listing and allows the user to act on generated data by placing an offer on the property directly through the system using natural language, receiving acceptance, rejection or counteroffer from the seller, track the status of the offer online and finalize the whole transaction online.
d. According to another aspect of the invention, a method is provided for buying or renting real estate property to users. In response to a user's offer, the system administrator analyzes the terms of the offer and communicates directly with the seller of the property in proposing user's offer terms. If the seller accepts the user's terms, the system administrator initiates the closing procedures. If the seller rejects the user's terms, the user may revise the offer. Each offer and outcome is stored by the system and available to subsequent users.
e. According to another aspect of the invention, all interactions between the users, system administrator and sellers are recorded by the system. Such information is then organized, systemized and stored online and is presented to subsequent users.

### BRIEF DESCRIPTION OF THE DRAWINGS

The present invention can be better understood by referencing the following drawings. The following drawings provide a thorough view of how the process described herein works.

FIG. 1 is a flowchart depicting basic steps for utilizing the interactive system for conducting search and buying/renting real estate properties.

FIG. 2 is a flowchart depicting a “Natural Search” approach for conducting natural language search and producing a limited number of search results.

FIG. 3 illustrates an exemplary screen display of the tools and windows that the user utilizes in conducting “Natural Search” online.

FIG. 4 is a flowchart depicting an approach for providing “Interactive Results” to user.

FIG. 5 is an exemplary screen shot of information and functions available to user after the

“Interactive Results” have been accepted.

FIG. 6 is an exemplary screen shot of “Interactive Results” provided to the user and information available to the user regarding each property.

FIG. 7 is a flowchart depicting an approach for making “Live Offer” on a user's selected property through computer system.

FIG. 8 comprises several exemplary screen shots of functionalities available to user as part of the “Live Offer” approach.

FIG. 9 is a flow diagram illustrating the implementation of the present invention through computer system.

### DETAILED DESCRIPTION OF THE INVENTION

A comprehensive and detailed overview of the invention is set forth below in order to provide a better understanding of the functionality of the system. The features and characteristics of the invention are detailed in the following sections: (1) Overview; (2) “Natural Search” approach; (3) “Interactive Results” approach; (4) “Live Offer” approach; (5) Implementation.

### Overview (1)

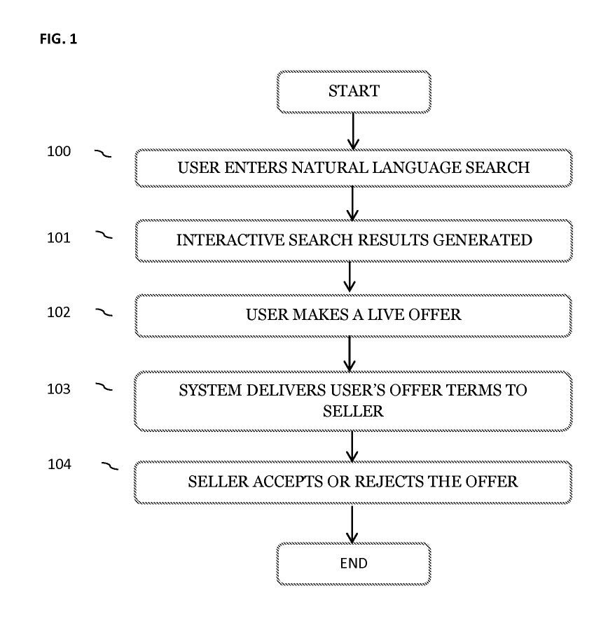

FIG. 1 is a flowchart that demonstrates a basic overview of the computer-implemented method that allows user to search and buy/rent real estate properties online. The term “real property” as used herein refers to any real estate inventory, including commercial and residential inventory. The process begins with step 100, where user, seeking to buy or rent real estate property, conducts search by utilizing natural language search terms. This approach allows to filter out unnecessary properties and tailor search results to user's unique needs and preferences.

According to one embodiment, a user enters search criteria in the user's own words or sentences, rather than conducting a search by way of a pre-selected set of criteria. The user is not limited to a particular set of words or phrases, and may enter any search criteria that is of interest to that particular user.

Once the completion of search criteria is satisfied, the system proceeds to the member registration phase. Before the system generates a set of interactive results as described in step 101, the system determines whether user is a “member.” According to one embodiment, if user is determined to be a member, the system proceeds to generating the user's interactive search results. If user is not a member, the system allows user to submit a request for membership by entering several pieces of personal information. The system subsequently approves or rejects the user's request, and either generates information based on the user's request, or denies user access to the system.

Upon attaining “member” status and response to user's individualized search criteria, the system administrator generates a set of limited number of real estate properties as described in step 101, which directly correspond to the user's particular search criteria. The “Interactive Results” are delivered to the user by way of telephone or email.

According to one embodiment, if user is dissatisfied with the generated “Interactive Results”, user can reject the results delivered by the system by providing reasons for such rejection and comments, and request a new list. The system determines whether user has reached the maximum number of search results and, if not, the system administrator analyzes user's reasons for rejection and comments, and generates a new limited number of “Interactive results”. User reaches the maximum number of search results if user has resubmitted the request for search results a specified number of times. User's comments and reviews are processed by the system and stored. Such comments and reviews, accessible by all subsequent users, make the process of selecting real property more efficient and thorough.

According to another embodiment, once a user receives and accepts “Interactive Results”, user has a unique ability to view prior offer history and specific data on each real property not available in prior art, comments and reviews by other users, as well as the opportunity to make an offer to the seller, as stated in step 102. As described in step 103, once user makes an offer on any property, the system administrator analyzes the terms of the offer and delivers the terms of the offer to the seller. The seller then either accepts, rejects or counters the terms of the offer, as described in step 104, and either a closing either takes place or the offer is revised. All interactions between users, sellers and system administrator, including but not limited to reviews, comments, offers and responses are recorded by the system, processed, organized, systemized and presented to subsequent users.

### “Natural Search” Approach (2)

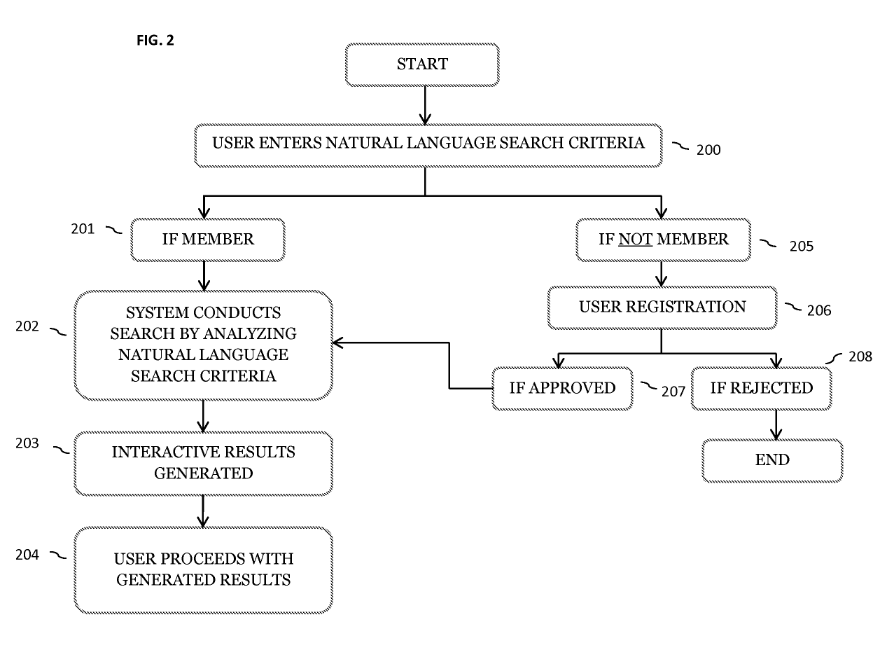

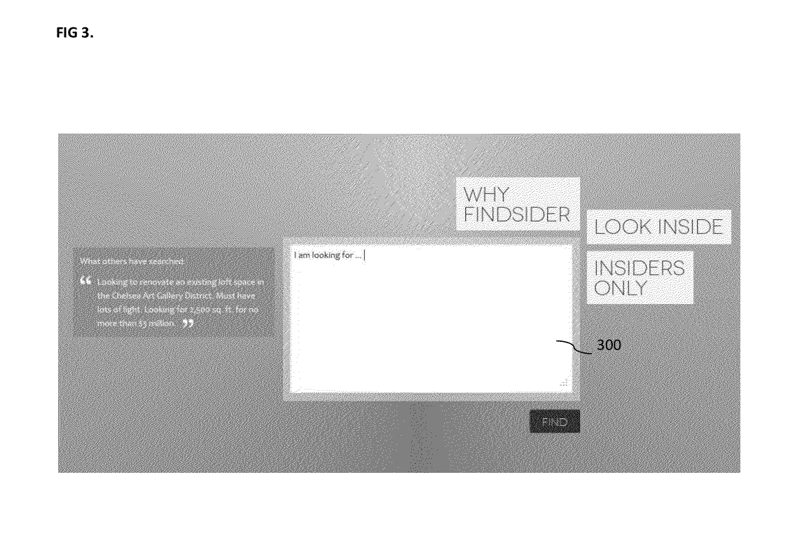

According to FIG. 2, a “Natural Search” approach allows user to utilize natural language in searching for real property. User has the option of narrowing the search by using natural language to describe exactly the type of real property user is looking to buy or rent. The user can tailor the search to his or her specific needs by providing criteria not available in traditional standardized search. “Natural Search” approach allows the system to filter user's search results by searching the database for inventory that matches user's non-standardized natural language search criteria. The process begins with step 200 where user seeking to buy or rent real estate enters natural language terms in order to conduct a search. This “Natural Search” approach is further described in FIG. 3.

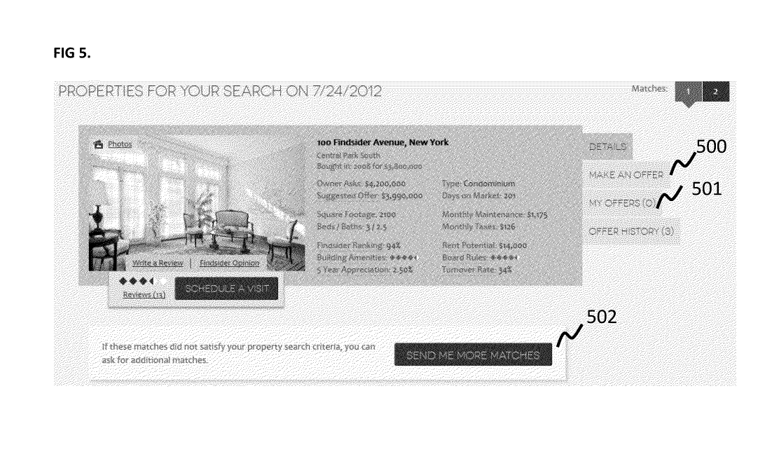

Once user enters search criteria using natural language, user is presented with a “member sign-in” option before being able to proceed with the search. As described in steps 201 and 202, if the user is confirmed as a “member,” the system administrator proceeds with the search based on user's specified natural language search criteria. The system administrator generates a list of limited number of results, and user may proceed accordingly with the various options as depicted in FIG. 5.

If user is not a registered member of the system, as described in step 205, the user is required to register as a member by providing several forms of personal information as described in step 206. Based on the user's personal data, the user is either approved or rejected as a “member”, as described in steps 207 and 208. If user is subsequently approved as a “member,” user may proceed with the search. Once rejected, the user may no longer utilize the system in his or her search.

FIG. 3 depicts an exemplary screen display presented to user to conduct the search. As seen in step 300, user enters natural language search terms in the search box. The user also has the ability to conduct non-standardized natural language search in several languages as described in step 301. According to one embodiment, user utilizes everyday words and phrases or any combination thereof to describe the type of real property user is seeking to buy or rent. The system administrator processes the search terms, accesses the back office database, and matches the natural language search criteria with the inventory available in the database.

### “Interactive Results” Approach (3)

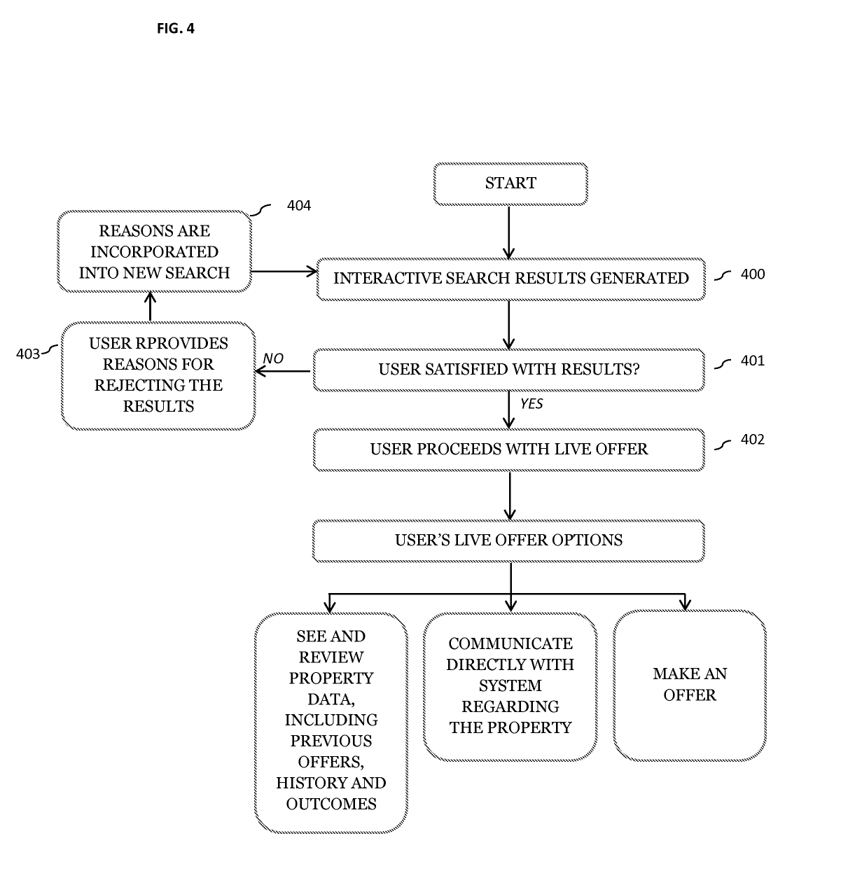

According to FIG. 4, the system generates a limited set of results based on user's natural language search criteria, and provides user with the opportunity to act on the generated results. Once user registers with the system and is approved as a “member,” user is able to finalize his or her search and subsequently receive results as previously described in FIG. 2 and FIG. 3.

According to one embodiment, once a user is approved as a member, a list of a limited number of properties is generated that best match user's criteria as described in step 400. The number of properties provided to the user is pre-determined by the system and tend to be clearly tailored to user's search. The search process for real property does not stop once a list of properties is generated and delivered to user, and, instead, becomes “interactive”. After user receives a set of results, user determines if the results are satisfactory based on the user's individualized property needs, as described in step 401. If user is satisfied with the property results generated by the system, user may access unique information regarding each property not available in prior art and opt to proceed with an offer on any/all of the generated property results, as described in step 402 and further depicted in FIG. 5.

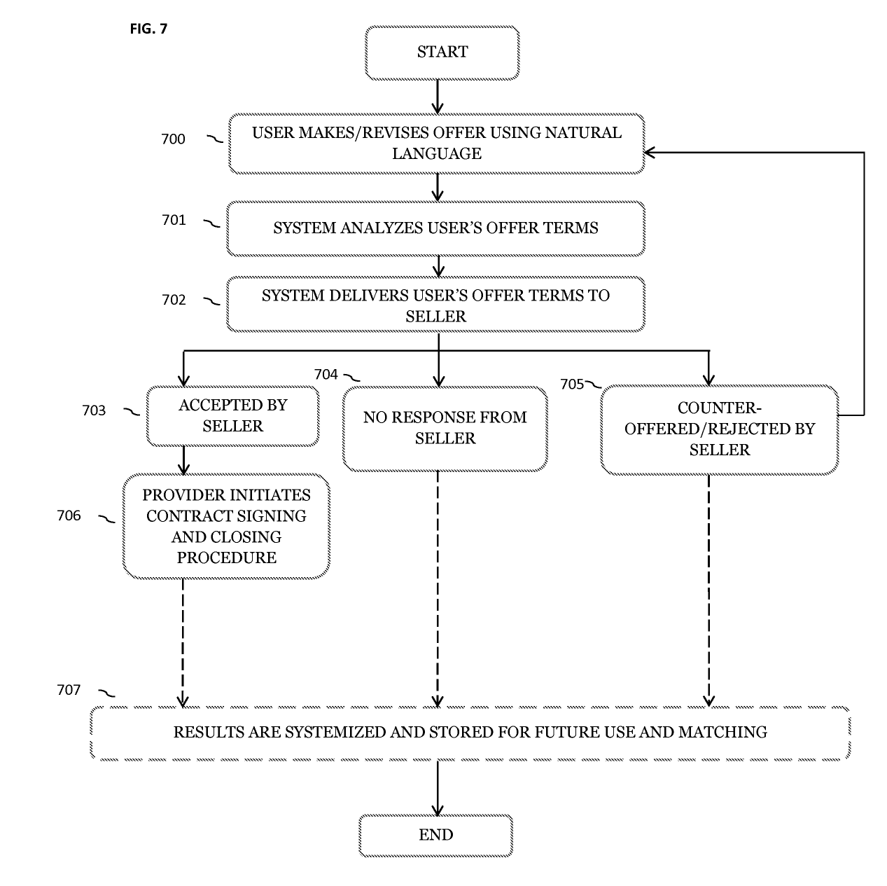

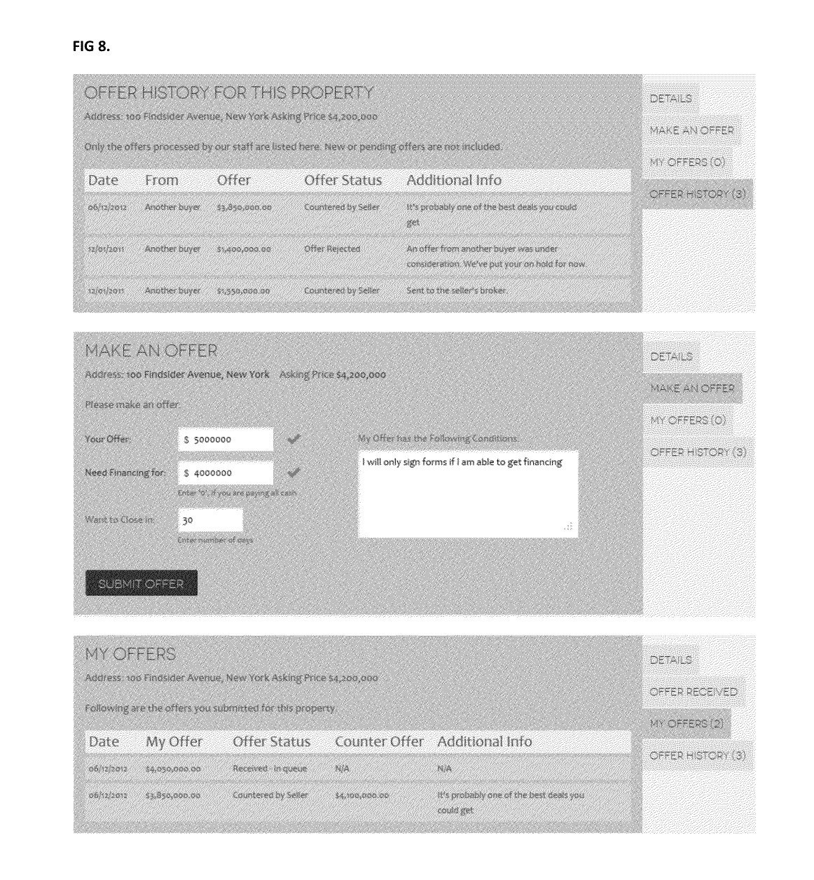

FIG. 5 is an exemplary screen shot of information and functionalities available to user after the “Interactive Results” have been accepted by user. User has access to property data like the asking price, building rules, open mortgage, comments, reviews and ratings by the system and other users, and whether there is a current offer made on that particular property listing. User also has the unique ability to view prior offers' history and outcomes as stated in step 700 and further described in FIG. 8. For example, a user who has accepted the search results may study the property data and determine that he is interested in purchasing a particular property because there is no mortgage on the property and because, based on the prior offers, he determines that he can afford to make a slightly higher offer. User than has the ability to make a customized offer on the property, as stated in step 701 and further described in FIG. 7 and FIG. 8.

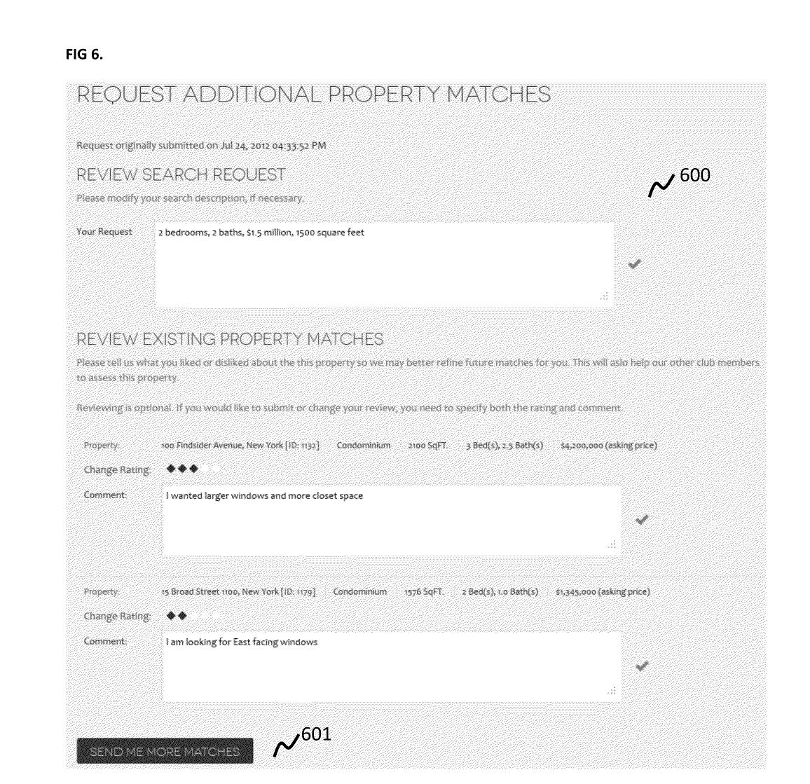

According to another embodiment, if the user is dissatisfied with the generated search results, the user may reject the results by providing reasons for such rejection and comments, as described in steps 403 and 702, and further depicted in FIG. 6. The system administrator processes and analyses the reasons for rejection, integrates such reasons into user's previous search, as stated in step 404, and generates a new narrow list of real estate properties, as stated in step 400. A user may reject the customized search results a certain number of times only. Additionally, user's reasons for rejection and comments are recorded, stored, processes, organized and made available to all subsequent users.

FIG. 6 is an exemplary screen shot of functions available to user who is dissatisfied with search results. As seen in step 600, user provides reasons for rejection and comments in natural language and requests more results as seen in step 601. In response to user's request, the system administrator analyzes user's reasons for rejection and is able to provide user with a tailored list of properties that best match user's preferences.

### “Live Offer” Approach (4)

According to FIG. 7, the “Live Offer” approach is implemented in addition to the “Natural Search” approach (2) and “Interactive Results” approach (3) to make the process of renting or buying real property more efficient. Once user conducts natural language search, accepts interactive search results and reviews unique information provided by the system, user has the option of making an offer on any or all of the generated properties using natural language as described in step 700 and further depicted in FIG. 8. Once an offer is made by user, the system administrator analyzes the terms of the offer and checks its database for a list of offer terms as they pertain to that particular property as described in step 701. If user's offer does not match the offer terms as listed in the system, the system automatically rejects user's offer, and user can make a new offer.

According to a specific embodiment, if user's offer is accepted by the system, the offer is subsequently presented to the seller as described in step 702. Once the offer has been submitted to the seller, the offer can be accepted by the seller as described in step 703, rejected by the seller or counter-offered by the seller as described in step 705, or there may simply be no response from the seller regarding the offer as described in step 704. If an offer is accepted by the seller, a contract is submitted and signed by both buyer and seller as described in step 706. If an offer is rejected or countered by the seller, user may make another offer.

According to a specific embodiment, all actions taken by the user and the seller regarding the specific property are systemized and stored within the database for future use and matching as described in step 707. Therefore, no offer is possible if another member has placed an offer. Moreover, recording all prior users' activity provides full access to the offer history and outcomes to the subsequent users, thereby giving the subsequent users an opportunity to make a plausible offer on the same property.

Several unique functions that are available to user as part of the “Live Offer” approach are described in FIG. 8. According to one embodiment, the user has the ability to view prior offers and outcomes by selecting the “Offer History” function. The information available to user as part of such function includes, among other things, the date and time of previous offers, the outcome of the offer and the reasons for rejection if any. This unique data allows the user to make an informed choice and submit a plausible offer.

According to another embodiment, if user, after reviewing the unique property data, determines that he or she is willing to make an offer, user can submit offer terms to the seller by utilizing “Make an Offer” function. User provides both the standardized terms pre-selected by the system, like the price and timing, and natural language terms, which are unique to each offer. Once the user enters the terms of the offer and clicks “submit offer” button, the system administrator analyzes the standardized and natural language terms of the offer and matches them against the data available on that particular property. If the offer terms are validated by the system, the system delivers the offer terms directly to the seller.

According to another embodiment, once the offer terms have been transmitted to the seller, user has a unique ability to see the status of his or her offer live online using the “My Offers” function. The information available to user includes the date and time the offer was submitted and whether the seller has accepted the offer, rejected the offer, or the offer is still under review.

### Implementation (5)

The aforementioned method for buying and renting of real estate is intended to streamline and improve the real estate process by allowing user to conduct narrow natural language search, receive highly customized results and unique information regarding each property not available in prior art and make a direct offer on the property. The present invention is particularly well suited for Internet applications. The invention may be implemented via different combinations of hardware and software and is not limited to particular hardware or software implementation.

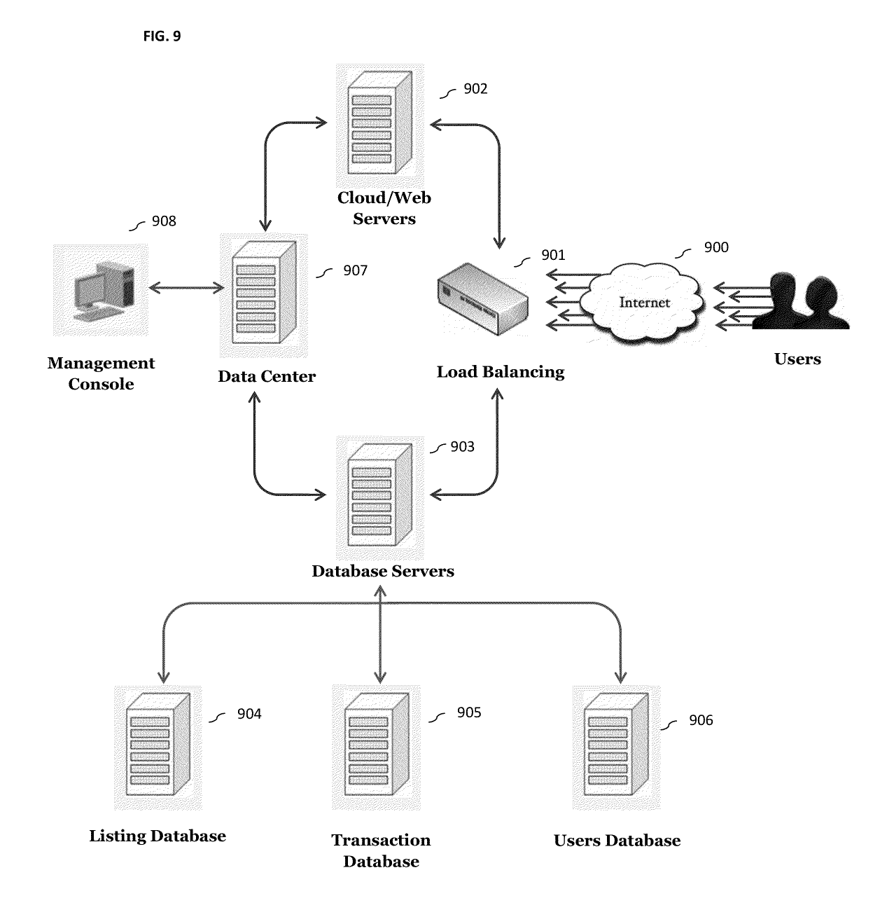

FIG. 9 is a diagram illustrating the embodiment of present invention. The embodiment supports the “Natural Search” approach, the “Interactive Results” approach and the “Live Offer” approach via the Internet. The computer system consists among other things of the load balancing 901, several servers 902 and 903, data center 907 and management console 908.

According to one embodiment, user accesses the system through the electronic communications network, the Internet, as seen in step 900, via multiple electronic devices, including computers, mobile phones, hand-held devices and the like. The load balancing 901 distributes information received from users across multiple servers, including cloud/web servers 902 and database servers 903. Servers execute processing, storage and capabilities of information transmitted over the Internet. Each server comprises one or more processors coupled with memory and storage devices and software packages that allow the system to function.

The primary databases include the Listing Database 904, the Transaction Database 905 and the User Database 906. The databases are interconnected and can be integrated into a single database. The servers are in turn connected to the Data Center 907, an environment where the whole infrastructure resides. The system administrator can access the Data Center 907 through the management console 908, which allows administrator to configure and monitor the system.

The novel method described here for searching and buying/renting of real properties provides several advantages over prior art. The computer system enables users to conduct natural language search, receive and customize interactive results, provide reviews and comments for each presented real estate property, access and utilize unique information about prior offers and outcomes stored by the system, place an offer and conclude the transaction online. In addition, the computer system described herein records and stores all interactions between users, sellers and system administrator, organizes, systemizes and presents such information to all subsequent users.

What is claimed is:

1. A computer-implemented method for searching for and selecting of real estate properties by a user, the method comprising computer-implemented steps of:
receiving non-standardized natural language search criteria from the user that indicates criteria that the user desires to have in the real estate property;
upon receiving non-standardized natural language search criteria from the user that indicates criteria that the user desires to have in the real estate property, selecting a limited pre-determined number of real estate properties from a database that best match the non-standardized natural language search criteria submitted by the user;
displaying to the user a limited pre-determined number of selected real estate properties and displaying indication that the user can accept or reject or refine one or more of the selected real estate properties;
upon receiving rejection by the user of one or more of the selected real estate properties, requiring the user to submit reasons and comments for rejecting one or more of the selected real estate properties;
upon receiving the user's reasons and comments for rejecting one or more of the selected real estate properties, selecting an additional limited pre-determined number of real estate properties that provide the best match for the non-standardized natural language search criteria and comments submitted by the user;
displaying to the user an additional batch of limited pre-determined number of real estate properties and displaying indication that the user can accept, reject or refine one or more of the selected real estate properties.

2. A computer-implemented method as recited in claim 1, wherein non-standardized natural language search criteria are a combination of any words, phrases, numbers, abbreviations or combinations thereof that user wishes to utilize to describe a desired real property.

3. A computer-implemented method as recited in claim 2, further comprising non-standardized natural language search criteria, characteristics and descriptions that can be entered in multiple languages.

4. A computer-implemented method as recited in claim 1, wherein the step of selecting a limited pre-determined number of real estate properties that best match the user's non-standardized natural language search includes selecting only a pre-determined number of real estate listings from a database as opposed to all property listings that match the non-standardized natural language search criteria submitted by the user.

5. A computer-implemented method as recited in claim 1, wherein displaying to the user a limited pre-determined number of selected real estate properties can be residential sales and rental real estate listings or commercial sale and rental real estate listings.

6. A computer implemented method of claim 1, wherein the step of selecting an additional limited pre-determined number of real estate properties based on the user's reasons and comments for rejecting the original results, includes analyzing by system administrator of user's reasons and comments for rejecting one or more of the originally selected real estate properties and integrating user's reasons and comments into a new search.

7. A computer-implemented method of claim 1, wherein upon receiving user's reasons and comments for rejecting one or more of the selected real estate properties, selecting an additional limited pre-determined number of real estate properties up to a specified number of times only.

8. A computer implemented method for buying or renting real property, the method comprising computer-implemented steps of:
enabling a user to submit a non-standardized natural language search criteria that indicates criteria that the user desires to have in real property;
providing to the user by system administrator a limited pre-determined number of real estate properties that best match the non-standardized natural language search criteria submitted by the user;
enabling the user to accept, reject or refine one or more of the real estate properties provided to the user, create reviews and comments to each real estate property presented to the user, review comments and reviews of other users and administrator, provide a rating for each real estate property presented, review ratings completed by other users and administrator, engage in a live chat with a moderator;
enabling the user to make a live offer on one or more of the real estate properties provided to the user;
in response to the offer and upon validating the terms of the offer, transmitting the terms of the offer to seller;
enabling the seller to respond the offer submitted by the user;
enabling the user to see live online and receive notifications of the status of the user's offer and the seller's response;
enabling the user to accept, reject or counter the counter offer that the seller made;
upon acceptance of the terms of the offer by the seller, finalizing the whole transaction of buying or renting real property online.

9. A computer-implemented method as recited in claim 8, wherein non-standardized natural language search criteria are a combination of any words, phrases, numbers, abbreviations or combinations thereof that user wishes to utilize to describe the real property.

10. A computer-implemented method as recited in claim 8, wherein a limited pre-determined number of real estate properties provided to the user can be one or more residential sales and rental real estate listings or commercial sale and rental real estate listings.

11. A computer-implemented method as recited in claim 8, wherein the step of enabling the user to utilize interactive fields includes enabling user to review prior offers made on each property provided to the user, including when such offers were made, the amounts of the offers, replies from owners' of presented real estate to such offers and the current status of such offers.

12. A computer-implemented method as recited in claim 8, wherein enabling the user to enter the terms of the offer for presented properties in non-standardized natural language.

13. A computer-implemented method as recited in claim 12, further comprising entering the terms of the offer for presented real estate in non-standardized natural language is any combination or words or phrases the user wishes to utilize to describe the terms of the offer.

14. A computer-implemented method as recited in claim 12, further comprising enabling the user to place the offer live online via a plurality of electronic devices including computers and mobile devices.

15. A computer-implemented method as recited in claim 8, wherein the step of validating the terms of the offer includes analyzing the user's natural language terms of the offer and comparing the terms of the user's offer against the prior offers that the seller accepted, rejected and countered and other information available on that particular property.

16. A computer-implemented method as recited in claim 8, wherein enabling the seller to respond to the offer submitted by the user includes enabling the seller to accept the user's offer, reject the user's offer or propose a counter-offer.

17. A computer-implemented method as recited in claim 8, wherein the information available to the user include the date and the terms of the offer, the amount of the offer, and whether the seller has acted on the user's offer, including accepting the offer, rejecting the offer, countering on the user's offer or if the user's offer is under review, and the administrator's comments, if any.

18. A computer-implemented method for recording, storing and organizing interactions within the system between users, sellers and system administrator, and presenting such interactions to other users, the method comprising computer implemented steps of:
recording interactions between user and system administrator at the time of the non-standardized natural language search and selection of one or more real estate properties;
upon recording interactions between user and system administrator at the time of the non-standardized natural language search and selection of one or more real estate properties, organizing, systemizing and storing such information and presenting such information via a network to users;
recording interactions between user and seller at the time of the live offer by the user and reply to such user's offer by seller on one or more real estate properties;
upon recording interactions between user and seller at the time of the live offer by the user and reply to such user's offer by seller on one or more real estate properties, organizing, systemizing and storing such information and presenting such information via a network to users;
recording user's comments and reviews of the real estate properties at every stage of the process;
upon recording user's comments and reviews, organizing, systemizing and storing such information and presenting such information via a network to users.

19. A computer-implemented method as recited in claim 18, wherein information recorded during interactions between user and system administrator includes reasons and comments for user's rejection of the one or more real estate properties provided to the user and ratings that such user provided to rejected real estate properties.

20. A computer-implemented method as recited in claim 18, wherein information recorded during interactions between user and seller includes including the offering price, the number of days the user intends to close, the user's conditions, if any, to the closing, the date of the offer, the seller's reply, including the acceptance, rejection or counteroffer, seller's comments to user's offer, if any and administrator's comments pertaining to user's offer on presented real property and seller's reply.

21. A computer-implemented method as recited in claim 18, wherein recorded, systemized and stored information is accumulated for each real property and presented to any or all current and/or subsequent users to whom such real estate property is currently or subsequently assigned.

22. A computer-implemented method as recited in claim 18, wherein the step of organizing and presenting information via a network to users, enables the user to view interactions for each real property between seller and other users and offer outcomes on each particular real property.

23. A computer system for buying and renting of real property by user comprising:
computer that is coupled to a digital network; and
electronic digital memory communicatively coupled to the computer, the memory including one or more sequences of computer program instructions, when executed, cause the computer to execute the steps of:
processing electronic digital information in form of non-standardized natural language search criteria, characteristics and descriptions received from the user that indicates criteria that the user desires to have in the real property;
establishing in electronic digital form, from electronic digital information received online, a limited pre-determined number of real properties that match the user's non-standardized natural language search criteria, characteristics and descriptions;
causing to be delivered to the user a limited pre-determined number of real properties that match the user's non-standardized natural language search criteria, characteristics and descriptions;
providing means to the user to accept, reject or refine one or more of the real estate properties provided to the user, create reviews and comments to each real estate property presented to the user, review comments and reviews of other users and administrator, provide a rating for each real estate property presented, review ratings completed by other users and administrator, engage in live chat with a moderator;
providing means to the user to make a live offer on one or more of the real estate properties provided to the user;
in response to receiving offer terms from the user, causing the offer terms to be transmitted to the seller;
providing means for finalizing the transaction online;
recording, organizing, systemizing and storing online all interactions between users and sellers regarding any particular property.

24. A computer system as recited in claim 23, wherein if the user rejects one or more customized results indicated by the natural language search criteria, requesting from the user reasons and comments for rejection of each real property provided to the user.

25. A computer system as recited in claim 24, further comprising in response to receiving rejection from the user, generating a new list of real properties that will incorporate user's reasons and comments for rejection of the previously provided real properties.

26. A computer system as recited in claim 24, further comprising in response to receiving a rejection for provided real property from the user, causing to be delivered to the user another set of customized results indicated by non-standardized natural language search criteria, characteristics and descriptions.

27. An computer system as recited in claim 23, wherein the step of transmitting the offer terms to the seller includes providing means to the seller to review the offer terms, including, accepting, rejecting or countering the user's offer terms, and providing seller's comments to such offer terms.

28. A computer system as recited in claim 23, wherein upon transmitting terms of the offer to the seller, causing to be delivered to the user notifications of the status of the user's offer and the seller's response, including the seller's reply, including the acceptance, rejection or counteroffer, seller's comments to the user's offer, if any and administrator's comments pertaining to the user's offer on presented real property.

29. A computer system as recited in claim 23, wherein following any interaction between the user and the system or the seller and the system, processing, recording and storing information online, systemizing such information for each real property and displaying such information to other users.
